(19) United States
(12) Patent Application Publication
(10) Pub. No.: US 2026/0287160 A1
(43) Pub. Date: Sep. 24, 2026

(54) NEAR FIELD COMMUNICATION THROUGH LIGHT FIXTURE DISPLAY

(71) Applicant: HARMAN PROFESSIONAL DENMARK APS, Aarhus (DK)

(72) Inventor: Christian Quist NIELSEN, Hobro (DK)

(21) Appl. No.: 19/473,911

(22) PCT Filed: Apr. 13, 2023
(86) PCT No.: PCT/EP2023/059648

§ 371 Date: Oct. 9, 2025

(51) Int. Cl. F21V 23/04

(52) U.S. Cl. CPC F21V 23/0435

(57) ABSTRACT

A light fixture includes a housing with an opening, wherein within the housing, a display with a front surface is positioned so that it is visible through the opening when a user looks at the light fixture from outside the housing. Additionally, an antenna of a wireless communication module is arranged behind the display in the viewing direction. This design effectively integrates the wireless communication module into the light fixture, concealing the antenna while optimizing space utilization, and enhancing the overall aesthetics and connectivity.

### TECHNICAL FIELD

Various examples of the disclosure generally relate to light fixtures. Various examples of the disclosure specifically relate to wireless communication modules in light fixtures, in particular to Near Field Communication (NFC) modules.

### BACKGROUND

Conventional solutions for enabling wireless near-field communication in lighting products have limitations due to the antenna's size and sensitivity to materials with high permeability. This can result in suboptimal performance of the wireless communication. Additionally, high IP rated products with metal housing can also present a challenge due to high magnetic permeability. These limitations have made conventional solutions less efficient and less flexible in terms of enabling near-field wireless functionality in lighting products.

### SUMMARY

Accordingly, there is a need for advanced techniques for wireless communication in light fixtures, which alleviate or mitigate at least some of the above-identified restrictions and drawbacks.

This need is met by the features of the independent claims. The features of the dependent claims define further advantageous examples.

In the following, the solution according to the present disclosure will be described with regard to the claimed light fixtures as well as with regard to the claimed methods for assembling and manufacturing light fixtures, wherein features, advantages, or alternative embodiments can be assigned to the other claimed objects and vice versa. In other words, the claims related to the light fixtures can be improved with features described in the context of the methods, and the methods can be improved with features described in the context of the light fixtures.

A light fixture is provided, which comprises a housing with an opening. The housing encloses an interior, in other words the opening corresponds to an aperture between the exterior and interior of the light fixture, wherein the interior of the housing can be accessible from the exterior through the opening. In other words, the opening or aperture extends from the outside to the inside, or connects the inside and the outside, or extends through the housing. The light fixture further includes a display with at least a front surface and a back surface, positioned within the opening, so that the front surface of the display is visible in a viewing direction through the opening when a user looks at the light fixture from outside the housing. In general, the housing comprises a display, wherein the display is arranged and fixed in the housing, within the opening of the housing, wherein additionally, an antenna of a wireless communication module is also arranged within or behind the opening, specifically behind the display in the viewing direction, i.e. the area of the antenna overlaps with the inner area of the opening (defined by the opening) and/or the display within the opening.

In various examples, a light fixture housing can sometimes be referred to as an enclosure or casing that is designed to contain and protect the internal components of the light fixture. In various examples, the housing may include further functional entities, such as a user interface module, or connector modules. The opening for the display, sometimes referred to as an assembly aperture for the display, allows for assembly of the display within the housing. The housing can be designed in various shapes and sizes, depending on the intended use and aesthetic preference. The opening in the housing allows for an Ingress Protection (IP) rated assembly of the display within the housing, Therefore, if also provides an IP protection for the wireless communication module, in particular the antenna of the communication module behind the display. The interior of the light fixture housing, which can also be referred to as the inner space, is the space within the housing where the components of the light fixture are contained. The housing may permit access to the interior, making it possible to install, repair, or replace components as needed.

In various examples, a display can be any electronic screen or panel that presents information, images, or graphics to the user. The front surface, also known as the viewing surface or face, is the part of the display visible to the user. Alternative terms for the display could include a screen, monitor, or interface. The display can be of different types, such as for example LED, OLED, or LCD, and can be used to present information, graphics, or images to the user. The wireless communication module's antenna can be designed for various wireless communication technologies, such as for example Wi-Fi, Bluetooth, RFID or NFC, and can be positioned near the display and in particular behind the display for improved signal reception and transmission. Accordingly, communication signals of the communication module or system pass through the display area.

In various examples, the viewing direction can correspond to a line of sight, wherein the front surface of the display is visible in the opening when a user is looking at the light fixture from the exterior of the housing. In this context, the user's perspective or viewpoint is taken into consideration. When the user observes the light fixture from an external position, the front surface of the display can be seen in the opening of the housing in the viewing direction. In general, the viewing direction may be referred to as any direction or axis from the outside of the light fixture through the opening to the interior of the light fixture. For example, the viewing direction may be referred to as a direction perpendicular to a surface plane of the display, or as a direction along a axis through the opening from the outside to the inside of the housing.

There are various ways and options for arranging the antenna behind the display in a light fixture. In various examples, an antenna of a wireless communication module is arranged behind the display in the viewing direction. The antenna, which can also be referred to as a wireless signal receiver and sender, is a component of the wireless communication module that enables the transmission and reception of wireless signals. The arrangement of the antenna behind the display in the viewing direction means that the antenna is positioned on the opposite side of the display relative to the user's perspective, ensuring that it may transmit through the opening, but is not visible to the user.

In some examples, behind the display can correspond to an arrangement, where the antenna and the display fully or partially overlap. In general, the areas of one or more of the opening the display and the antenna can partially or fully overlap. For example, the projections of the areas onto a plane perpendicular to a direction or axis extending through the opening can fully or at least partially overlap. In other words, the antenna can be positioned partially or fully overlapping the display behind the display, depending on the desired design and functionality.

In other words, the antenna and display components can have a spatial overlap, where the regions they occupy coincide when projected onto a plane orthogonal to the viewer's line of sight. The display and the antenna are positioned sequentially along the same axis, the axis (viewing direction) intersecting both, typically perpendicular to the viewing direction. The display is the first component that a viewer encounters, and the antenna is positioned directly behind it, so that the viewer does not see it. The display and antenna are stacked along the same axis.

In this regard, an antenna partially extending along the backside display surface might provide adequate signal reception and transmission while reducing the overall complexity of the light fixture.

The antenna can be arranged in a plane parallel to the display, in other words parallel to the area defined by the opening (opening edges), which can help to optimize the antenna's performance and maintain a compact design. In some examples, the antenna may be arranged in an angle to the display. In some cases, the antenna may be configured to have the same size as the display, ensuring a seamless integration of the components. Alternatively, the antenna could be designed to be larger or smaller than the display, depending on the specific requirements of the wireless communication module and the available space within the light fixture's housing.

The antenna can be arranged centrally or concentrically, aligning with the center of the display to maintain a balanced appearance and functionality. However, it could also be positioned off-center or asymmetrically, or in an angle to the opening, if certain design constraints or requirements dictate such an arrangement.

In various examples, the antenna behind the display is arranged in the inside of the housing, specifically adjacent to a back surface of the display (e.g. the back surface of the backlight module), and is thereby also within the opening or arranged behind the opening in the inside of the light fixture. An area of the antenna may be arranged such that along an axis or direction extending through the opening, the area of the antenna is arranged behind, in other words at least partially overlapping with and/or extending along the opening. In such a way, a transmission direction of the antenna may be through the display and through the opening.

These different options for arranging the antenna behind the display provide flexibility in designing a light fixture that can cater to various aesthetic preferences, functional requirements, and space constraints while ensuring effective wireless communication capabilities.

The provided techniques address the challenges associated with NFC antenna placement in lighting products. By positioning the NFC antenna behind the user interface display, the invention overcomes limitations related to available space, material permeability, and design constraints in compact and high IP rated lighting fixtures. The described configuration effectively solves the technical problem of finding a suitable NFC antenna placement that doesn't negatively impact the antenna's performance or interfere with the fixture's design. By placing the NFC antenna behind the display, the invention leverages the available surface area on the fixture's user interface, which is already allocated for the display. This approach ensures that the NFC antenna does not occupy additional space and does not require any special handling from a mechanical perspective, as the display will always have a clear view on a lighting product. Furthermore, the arrangement of the NFC antenna behind the display does not significantly affect the magnetic field from the NFC antenna, allowing the magnetic field to couple through the display and out to the front of the unit. As a result, a user can interact with the fixture's user interface using an NFC-enabled mobile device for data exchange. Thereby NFC antenna placement is allowed in light fixtures, that maximizes available space, does not interfere with the antenna's performance or fixture design, and allows for seamless interaction between the lighting fixture and NFC-enabled devices.

A corresponding method for assembling a light fixture is includes providing a housing of the light fixture with an opening, providing a display with a front surface, providing a wireless communication module, and assembling the display and the wireless communication module in the interior of the housing. The front surface of the display is visible through the opening when a user looks at the light fixture from outside the housing, and the antenna of the wireless communication module is arranged behind the display in the viewing direction.

The assembly process can involve various techniques and tools, depending on the specific design and components of the light fixture. This can include attaching the display and antenna to the housing using screws, adhesive, press-fits or other fastening methods. Additionally, the assembly process can involve electrically coupling the various components, such as a control PCB, FPC connector, and wireless communication module, to ensure proper functionality and operation of the light fixture.

The method can further be modified to assemble any light fixture as described in the present disclosure.

It is to be understood that the features mentioned above and features yet to be explained below can be used not only in the respective combinations indicated, but also in other combinations or in isolation, without departing from the scope of the present disclosure. In particular, the features mentioned above and those yet to be explained below may be used not only in the respective combinations indicated, but also in other combinations or in isolation without departing from the scope of the disclosure.

### BRIEF DESCRIPTION OF THE DRAWINGS

These and other objects of the invention will be appreciated and understood by those skilled in the art from the detailed description of the preferred embodiments and the following drawings in which like reference numerals refer to like elements.

FIG. 1 schematically illustrates a light fixture, according to various examples.

FIG. 2 schematically illustrates a user interface with a display, which is included in the light fixture of FIG. 1, according to various examples.

FIG. 3 schematically illustrates a top view of the user interface of FIG. 2, according to various examples.

FIG. 4 schematically illustrates a cross sectional view of the user interface of FIG. 2, according to various examples.

FIG. 5 schematically illustrates steps of a method for assembling a light fixture, according to various examples.

### DETAILED DESCRIPTION OF EXAMPLES

In the following, embodiments of the invention will be described in detail with reference to the accompanying drawings. It should be understood that the following description of embodiments is not to be taken in a limiting sense. The scope of the invention is not intended to be limited by the embodiments described hereinafter or by the drawings, which are taken to be illustrative examples of the general inventive concept. The features of the various embodiments may be combined with each other, unless specifically noted otherwise.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, elements, or other physical or functional units shown in the drawings or described herein may also be implemented by an indirect connection or coupling.

Hereinafter, techniques will be described that relate to utilizing the existing surface area of a display included in a housing of a light fixture for a more efficient and flexible way of enabling wireless communication of the light fixture.

Conventional solutions for enabling wireless communication in lighting products have limitations due to the antenna's size and sensitivity to materials with high permeability. This can result in suboptimal performance of the wireless communication or even complete failure. Additionally, high IP rated products with metal housing can also present a challenge for wireless communication signals. These limitations have made conventional solutions less efficient and less flexible in terms of enabling NFC functionality in lighting products.

When enabling NFC in a lighting product it can be difficult to find a placement of the NFC antenna due to a NFC antenna must have a certain size to get a good coupling distance to a NFC enabled mobile device. The NFC antenna must not be place behind materials with high permeability as this will prevent the magnetic field to reach the NFC antenna from the NFC enabled mobile device. It is also preferred not to place the NFC antenna near materials with high permeability, as this will impact the performance of the NFC antenna. This limits the placement possibilities that does not interfere with the antenna. For example, in moving head lighting fixtures the user interface assembly typically has limited space available due to having cable connections, menu buttons and display on the same side of the product base. This is especially the case for moving head fixtures with a compact base design. In high IP rated products with metal housing, the placement can be a big challenge as it will require a housing surface which does not have materials with high permeability.

According to the inventive concept, a surface area on the fixture user interface is used, which is already allocated for the display. Hence the NFC antenna does not take up more space and does not require any special handling from a mechanical perspective as the display will always have a clear view on a lighting product.

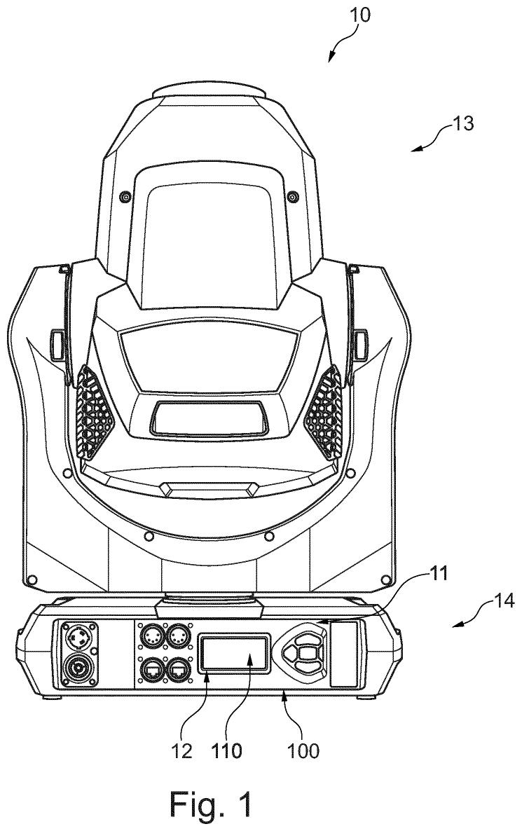

FIG. 1 schematically illustrates a light fixture 10, according to various examples.

In FIG. 1, an overview image of a moving head light fixture 10 is shown. The light fixture 10 comprises a base 14 and a moving head 13. The base 14 of the light fixture 10, comprises a user interface module 100 with the display 110. In the base 14, within the user interface module 100, the housing 11 of the light fixture 10 includes an opening 12, in which the display 110 is arranged and sealed.

The assembly of the display 110 with the housing 11 has an Ingress Protection (IP) rating against ingress of solid objects and water into the housing 11.

The light fixture 10 further includes a wireless communication module (not shown in FIG. 1), particularly a wireless communication module (or transceiver) for short-range communication, in particular an active or a passive component to be used in a wireless (short-range) communication system. For example, such passive components may be referred to as contactless identification elements or wireless identification elements, which encompass a range of passive components that store information and respond to signals from active devices in contactless communication systems. The wireless communication module can be for example a Near-Field Communication (NFC) tag or a Radio Frequency Identification (RFID) tag. The arrangement of the components within the light fixtures housing will be describe in further detail with regard in the following. An antenna 121 is arranged in the opening behind the display, as will be described in the following in further detail.

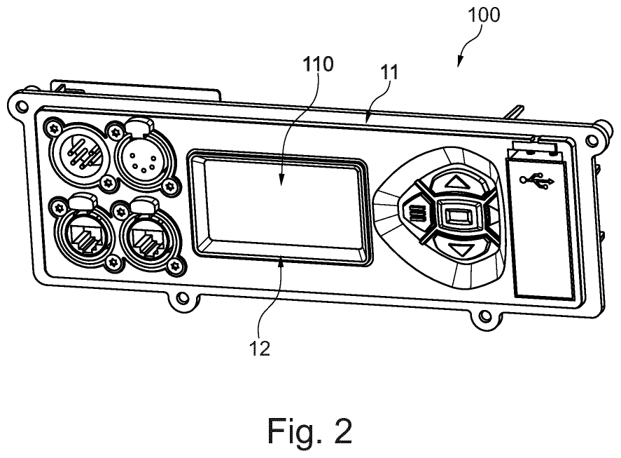

FIG. 2 schematically illustrates a user interface 100 with a display 110, which is included in the light fixture 10 of FIG. 1, according to various examples.

FIG. 2 shows a front view of the user interface module 100, wherein the display 110 and front surface 111 of the display are shown. The display 110 is located in the interior of the housing 11 such that the front surface 111 is visible through the opening 12 in a viewing direction when a user of the light fixture 10 is looking at the light fixture 10 from outside the housing 11. The user interface module is assembled into the light fixture housing 11, in this regard may be referred to as a part of the housing 11, in which the opening 12 for the display 110 is provided.

In various examples, the magnetic coupling of a standard display 110 does not, in a significant way, impact the magnetic field from an NFC antenna, which therefore can be arranged additionally behind the display 110 within the opening 12. Accordingly, one or more NFC antennas can be placed on the backside of the user interface display 110 in the light fixture 10. This will allow the magnetic field to couple trough the display and out to the front of the unit, through the light fixture housing. Thereby, an NFC enabled mobile device can interact with a user of the light fixture 10 interface for data exchange.

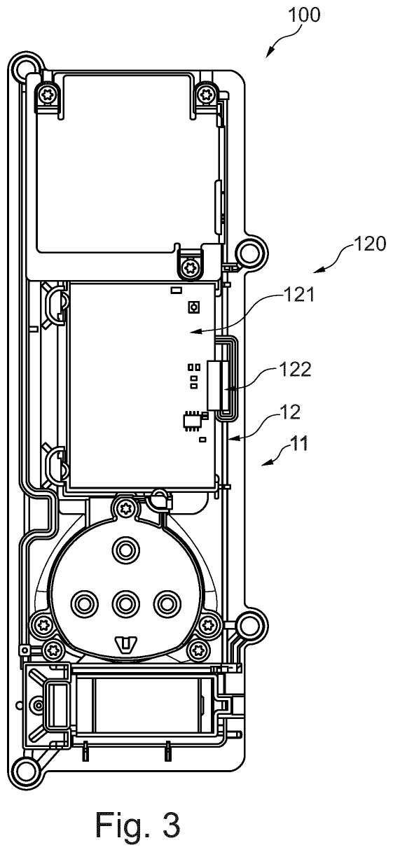

FIG. 3 schematically illustrates a top view of the user interface 100 of FIG. 2, according to various examples.

In FIG. 3, the back side of the user interface module 100 is shown as seen from the interior of the light fixture in direction towards the exterior, wherein an NFC antenna 121 of a wireless communication module 120 is visible. The NFC antenna 121 covers the area of the opening 12 and the back surface of the display.

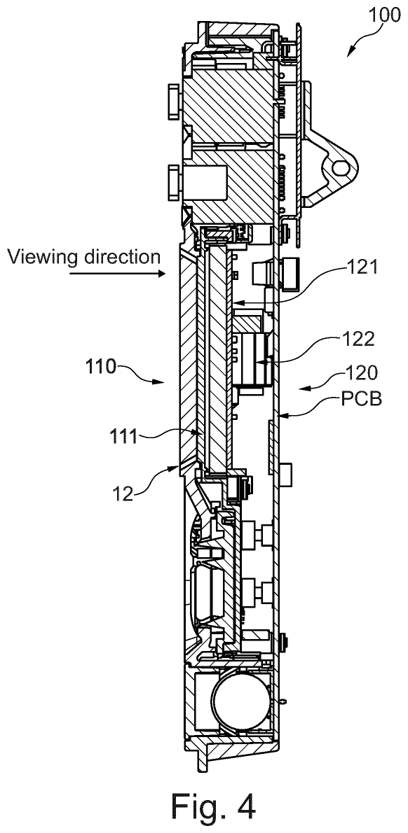

The display is located within the opening 12 such that the front surface is visible through the opening 12 in a viewing direction when a user of the light fixture 10 is looking at the light fixture 10 from an exterior of the housing 11. In this example, the display is sealed into the opening and provides an IP rating to the light fixture. The NFC antenna 121 of the wireless communication module is arranged in a stacked configuration with a control PCB and the display, as further described in connection with FIG. 4. The wireless communication module may comprise a plurality of components, which may include an antenna, control circuitry, and a connector to further components on a separate control PCB or arranged on the PCB assembly of the user interface 100. As can be seen, the NFC antenna 121 extends at least partly in parallel along the the area of the opening and the display.

The NFC antenna 121 is manufactured as a flexible printed circuit board (FPC) and is glued to a back surface of the display 110, which allows a simple flex connection to the user interface PCB assembly as typically used in display assemblies. It could also be FR4-based with normal board to board connectors. The antenna 121 has adhesive on its backside to firmly stick to the back of the display 110.

FIG. 4 schematically illustrates a cross-sectional view of the user interface 100 of FIG. 2, according to various examples.

In FIG. 4, a cross-sectional view of the display 110 and the antenna 121 is shown, wherein the directly adjacent arrangement of the antenna 121 and the back surface of the display 110 is visible, and further the flexible connector 122 to a control PCB of the user interface 100 is illustrated. The antenna 121 is arranged in the viewing direction behind the display 110.

The antenna 121 is glued to a backlight module of the display 110. The antenna 121 is electrically coupled to a control PCB within the housing 11 by a flexible printed circuit (FPC) connector 122, while being mechanically decoupled from the PCB by the FPC. The control PCB is arranged substantially parallel to the antenna 121 and spaced from the antenna 121 by a predetermined distance. For example, the control PCB and the antenna 121 can be arranged within a distance along viewing direction, or in a perpendicular direction from each other.

As can be seen in FIG. 4, the control PCB, i.e. the PCB assembly of the user interface module 100, is arranged essentially parallel to the display 110 and the antenna 121 and spaced from the antenna by an air gap bridged by the flexible connector (122).

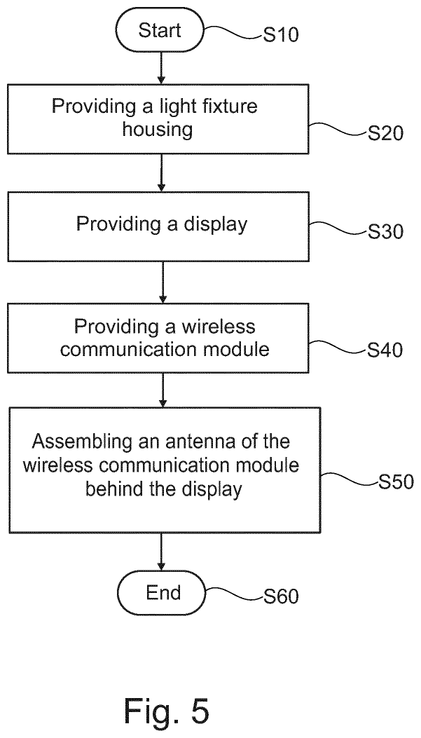

FIG. 5 schematically illustrates steps of a method for assembling a light fixture 10, according to various examples.

The method starts in step S10. In step S20, a housing of the light fixture is provided, including an opening, wherein an interior of the housing is accessible through the opening. In step S30, a display with a front surface is provided. In step S40, a wireless communication module is provided. In step S50, the display and the wireless communication module are assembled in the interior of the housing, optionally partly within or extending through the metal housing, wherein the front surface of the display is visible through the opening in a viewing direction when a user of the light fixture is looking at the light fixture from outside the housing, and an antenna of the wireless communication module is arranged in the viewing direction behind the display. The method ends in step S60.

From the above said, the following general conclusions can be drawn:

The antenna can extend at least partly in parallel along the display. This arrangement of the antenna can improve signal reception and transmission by increasing the effective surface area for wireless communication. The antenna can be designed in various shapes and sizes, and can be made from a range of materials, such as copper or other conductive materials.

The light fixture can comprise a base and a head that is movable relative to the base, with the display and the wireless communication module arranged within the base of the light fixture. The inclusion of a movable head can provide greater flexibility in directing the light output, allowing the user to adjust the light fixture's focus according to their needs. The base can house the display and wireless communication module, enabling a compact design and protecting the components from external damage.

The antenna can be arranged directly adjacent to a back surface of the display in the viewing direction. By positioning the antenna directly adjacent to the display's back surface, it can reduce the overall thickness of the light fixture and improve the signal reception and transmission performance. This arrangement can also help minimize interference between the display and the antenna.

The assembly of the display with the housing can have an Ingress Protection (IP) rating against the ingress of solid objects and water into the housing. An IP rating ensures that the light fixture is protected against the entry of solid objects, such as dust or debris, and water, enhancing its durability and making it suitable for various indoor and outdoor environments. The specific IP rating can be chosen based on the intended use and required protection level.

The wireless communication module can comprise a wireless communication module for short-range communication. Short-range communication can enable communication with nearby devices, such as smartphones or tablets, for control or data transfer purposes. The module can support various short-range communication technologies.

In general, short range communication systems, such as Near Field Communication (NFC) or Radio Frequency Identification (RFID) systems are wireless communication technologies that enables the identification, tracking, and data exchange between active components, such as transceivers or readers, and passive components, i.e. NFC/RFID tags, over short distances using radio waves.

In an NFC/RFID system, the active component (transceiver/reader) sends out a signal to the passive component (tag). The tag, which stores information, responds by transmitting its stored data back to the active component. The active component then processes the received data for various applications, such as inventory management, access control, or controlling purposes. RFID systems can operate at various distances and frequencies, making them suitable for a wide range of applications, including supply chain management, asset tracking, and transportation.

The wireless communication module can comprise a Near-Field Communication (NFC) tag. The inclusion of an NFC tag can enable contactless communication with compatible devices, allowing for easy pairing, data transfer, or control functions. This can provide added convenience and functionality for the user. In general a tag for contactless communication systems may refer to a passive component of the contactless (wireless) communication system and may comprise an antenna and control circuitry such as an integrated circuit.

The wireless communication module can comprise a Radio Frequency Identification (RFID) tag. An RFID tag can enable the light fixture to communicate with or using RFID transceivers or devices, allowing for identification, tracking, or control purposes of specific light fixtures. This feature can be particularly useful in commercial or industrial applications.

NFC/RFID tags, in general wireless communication modules, may comprise an integrated circuit (IC) and an antenna, which work together to facilitate wireless communication with an active reader or transceiver. The IC, also known as the control circuitry or microchip, is responsible for processing and storing information, while the antenna enables the tag to receive and transmit signals. The antenna may be arranged such that a substantial part of its area is located within the opening, in other words behind the display and/or the opening, of the housing. In some examples, the overlapping area of the antenna and the opening and/or display may be bigger than 20%, or 40%, or 60%, or 80% or 90% or equal to 100% (i.e. the complete antenna area is located such that is within the opening and behind the display. Also the IC may be arranged in the same way as the antenna behind the display/opening.

In a typical NFC/RFID tag, the control circuitry is embedded within the tag's substrate, which can be made of various materials such as paper, plastic, or even metal. The antenna, usually constructed from conductive materials like copper or aluminum, is connected to the IC either through a direct attachment or by using conductive adhesive. The antenna can take various shapes and configurations, depending on the desired operating frequency, range, and application.

The passive NFC/RFID tag operates by harvesting energy from the electromagnetic field generated by the active reader or transceiver. When the tag is in proximity to the reader, the antenna captures energy from the reader's radio waves and uses it to power the IC. The IC then modulates the electromagnetic field to transmit the stored data back to the reader, enabling wireless identification, tracking, and data exchange.

In the context of an FPC (Flexible Printed Circuit), passive contactless identification elements, such as NFC/RFID tags, can be integrated into the flexible circuitry to enable wireless communication with an active reader or transceiver. The FPC provides a thin, lightweight, and flexible substrate for both the control circuitry and the antenna, making it suitable for space-constrained or mechanically dynamic applications.

The control circuitry, or integrated circuit (IC), is mounted onto the flexible polymer substrate, typically made of materials like polyimide. This IC is responsible for processing and storing information, and it can be connected to other electronic components on the FPC using conductive traces.

The antenna, which enables the tag to receive and transmit signals, is also integrated into the FPC. It can be fabricated using conductive materials such as copper or silver, and it is patterned onto the flexible substrate using various techniques, such as etching or screen printing. The design of the antenna is influenced by factors such as operating frequency, range, and application requirements. When the FPC-based NFC/RFID tag is in proximity to an active reader or transceiver, the antenna captures energy from the reader's radio waves and uses it to power the control circuitry. The IC then processes the incoming signal and modulates the electromagnetic field to transmit the stored data back to the reader.

The antenna can be in direct contact with a backlight module of the display. By placing the antenna in direct contact with the backlight module, it can further reduce the thickness of the light fixture and potentially improve the signal reception and transmission performance. This arrangement can also help with heat dissipation from the backlight module.

The antenna can be connected to a control printed circuit board (PCB) within the housing by a flexible printed circuit (FPC) connector. This connection method allows for greater flexibility in the positioning of the antenna and control PCB within the housing. The FPC connector can be designed in various lengths and configurations, providing versatility in the assembly and layout of the light fixture's components.

The control PCB can be arranged substantially parallel to the antenna and spaced from the antenna by a predetermined distance. This arrangement can help minimize interference between the control PCB and the antenna, while also providing a compact design. The predetermined distance can be determined based on the specific requirements of the light fixture and the wireless communication module.

The antenna can be realized as a flexible printed circuit board (FPC). Using an FPC for the antenna allows for a flexible and lightweight design, which can be easily integrated into the light fixture's housing. This can also enable the antenna to conform to various shapes and sizes, providing versatility in the overall design of the light fixture.

The antenna can be realized as a printed circuit board (PCB). A PCB-based antenna design can provide a more rigid and durable structure, which can be beneficial in certain applications or environments. The PCB can be designed in various shapes and sizes to suit the specific requirements of the light fixture and wireless communication module.

The antenna can be glued to a back surface of the display. Attaching the antenna to the display's back surface using adhesive can further reduce the overall thickness of the light fixture and potentially improve signal reception and transmission performance. This method of attachment can also simplify the assembly process and reduce the need for additional fasteners or connectors.

It is to be understood that the described techniques have been described with regard to a user interface panel assembled in the light fixture including a display, however it is clear that they can not only be used in conjunction with a user interface panel, but with any display of a light fixture. It would even be possible that instead of a display, the light emitting opening of the light fixture may be used for wireless communication. Further, any communication module and/or antenna may be used based on any communication standard, which is thereby allowed to be assembled within a light fixture with improved connectivity.

Although the disclosed techniques have been described with respect to certain preferred embodiments, equivalents and modifications will occur to others skilled in the art upon the reading and understanding of the specification. The present disclosure includes all such equivalents and modifications and is limited only by the scope of the appended claims.

For illustration, above, various scenarios have been disclosed in connection with light fixtures, while similar techniques may be applied to any other encased electronic devices.

1. A light fixture comprising:
a housing including an opening, wherein an interior of the housing is accessible through the opening,
a display with a front surface located in the interior such that the front surface is visible through the opening in a viewing direction from outside the housing, and
an antenna of a wireless communication module which is arranged in the viewing direction behind the display

2. The light fixture of claim 1, wherein the antenna extends at least partly in parallel along the display

3. The light fixture of claim 1, wherein the light fixture comprises a base and a head that is movable relative to the base, and wherein the display and the wireless communication module are arranged within the base of the light fixture.

4. The light fixture of claim 1, according to one of the wherein the antenna is arranged directly adjacent to a back surface of the display in the viewing direction.

5. The light fixture of claim 1, wherein an assembly of the display with the housing has an Ingress Protection (IP-) rating against ingress of solid objects and water into the housing.

6. The light fixture of claim 1, wherein the wireless communication module comprises a wireless communication transceiver for short-range communication.

7. The light fixture of claim 1, wherein the wireless communication module comprises a Near-Field Communication (NFC) tag.

8. The light fixture of claim 1, wherein the wireless communication module comprises a Radio Frequency Identification (RFID) tag.

9. The light fixture of claim 1, wherein the antenna is direct contact with a backlight module of the display.

10. The light fixture of claim 1, wherein the antenna is connected to a control printed circuit board (PCB) within the housing by a flexible printed circuit (FPC) connector

11. The light fixture of claim 10, wherein the control printed circuit board (PCB) is arranged substantially parallel to the antenna and spaced from the antenna by a predetermined distance.

12. The light fixture of claim 1, wherein the antenna is realized as a flexible printed circuit board (FPC).

13. The light fixture of claim 1 proceeding wherein the antenna is realized as a printed circuit board (PCB).

14. The light fixture of claim 1 wherein the antenna is glued to a back surface of the display

15. A method for assembling a light fixture, comprising
providing a housing of the light fixture including an opening, wherein an interior of the housing is accessible through the opening;
providing a display with a front surface;
providing a wireless communication module; and
assembling the display and the wireless communication module in the interior of the housing, wherein the front surface of the display is visible through the opening in a viewing direction from outside the housing, and wherein an antenna of the wireless communication module is arranged in the viewing direction behind the display

16. The method of claim 15, further comprising:
providing a base and a head that is movable relative to the base; and
arranging the display and the wireless communication module within the base of the light fixture.

17. The method of claim 15, further comprising extending the antenna extends at least partly in parallel along the display.

18. The method of claim 15, further comprising arranging the antenna directly adjacent to a back surface of the display in the viewing direction.

19. The method of claim 15, further comprising providing an Ingress Protection (IP-) rating against ingress of solid objects and water into the housing for an assembly of the display with the housing.

20. The method of claim 15, wherein the wireless communication module comprises a wireless communication transceiver for short-range communication.
